(19) United States
(12) Patent Application Publication
(10) Pub. No.: US 2026/0298753 A1
(43) Pub. Date: Oct. 1, 2026

(54) Pressure Detector for a Tire

(71) Applicant: A-RIM Ent. Co., Ltd., Changhua City (TW)

(72) Inventor: ChunKai Huang, Changhua City (TW)

(21) Appl. No.: 19/090,929

(22) Filed: Mar. 26, 2025

(51) Int. Cl. G01L 17/00; B60C 23/00

(52) U.S. Cl. CPC G01L 17/00; B60C 23/00

(57) ABSTRACT

A pressure detector includes a shell and an electronic shield. The shell includes a box and a cover. The box includes a groove. The cover is connected to the box, thereby covering the groove. The electronic shield is inserted in the groove and connected to the cover, thereby providing a space between the electronic shield and the cover.

### BACKGROUND OF INVENTION

### 1. Field of Invention

The present invention relates to a tire and, more particularly, to a pressure detector for a tire.

### 2. Related Prior Art

Flat tires are not rare causes for car accidents. Flat tires can cause grave accidents when vehicles travel fast. Hence, it is important to monitor the pressure in tires.

To this end, pressure detectors have been devised to allow drivers to monitor the pressure in tires of vehicles. Thus, the drivers can take precautions to reduce catastrophic accidents.

However, the use of the conventional pressure detectors is not without any problems. A typical pressure detector includes a large circuit board. An antenna, a processor, a pressure gauge and a battery are located on a same side of the circuit board. The outlay of these components on the circuit is unbalanced. Vibrations and noises of the pressure detectors are inevitable when they are used in tires in rotation.

The present invention is therefore intended to obviate or at least alleviate the problems encountered in the prior art.

### SUMMARY OF INVENTION

It is the primary objective of the present invention to provide a stable pressure detector for a tire.

To achieve the foregoing objective, the pressure detector includes a shell and an electronic shield. The shell includes a box and a cover. The box includes a groove. The cover is connected to the box, thereby covering the groove. The electronic shield is inserted in the groove and connected to the cover, thereby providing a space between the electronic shield and the cover.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a pressure detector according to the first embodiment of the present invention;

FIG. 2 is a cross-sectional view of the pressure detector depicted in FIG. 1;

FIG. 3 is an exploded view of the pressure detector shown in FIG. 1;

FIG. 4 is another exploded view of the pressure detector than shown in FIG. 3;

FIG. 5 is another exploded view of the pressure detector than shown in FIG. 4;

FIG. 6 is a cross-sectional view of the pressure detector taken along a line I-I shown in FIG. 1;

FIG. 7 is a cross-sectional view of the pressure detector taken along a line II-II shown in FIG. 1;

FIG. 8 is a block diagram of the pressure detector shown in FIG. 1; and

FIG. 9 is a perspective view of a pressure detector according to the second embodiment of the present invention.

### DETAILED DESCRIPTION OF EMBODIMENTS

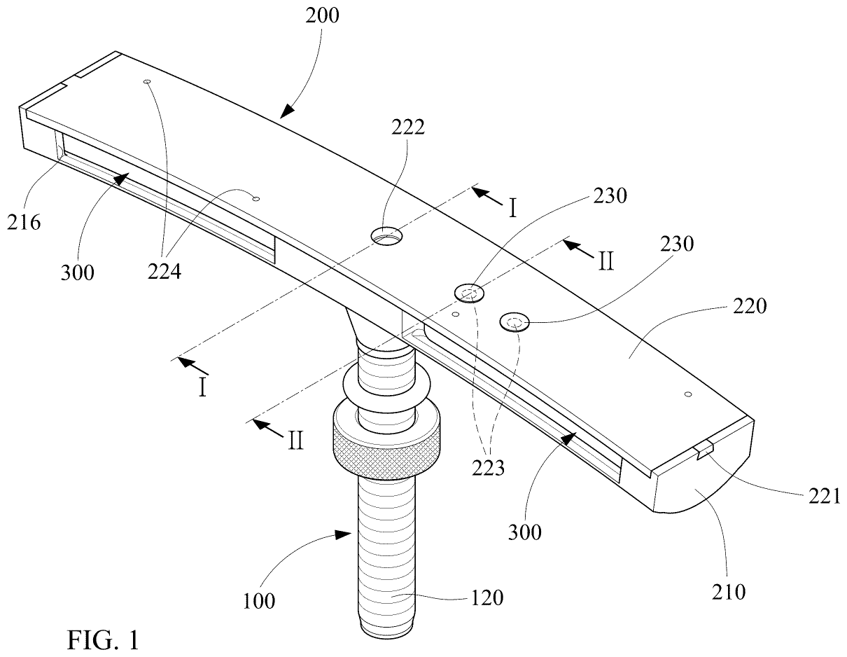

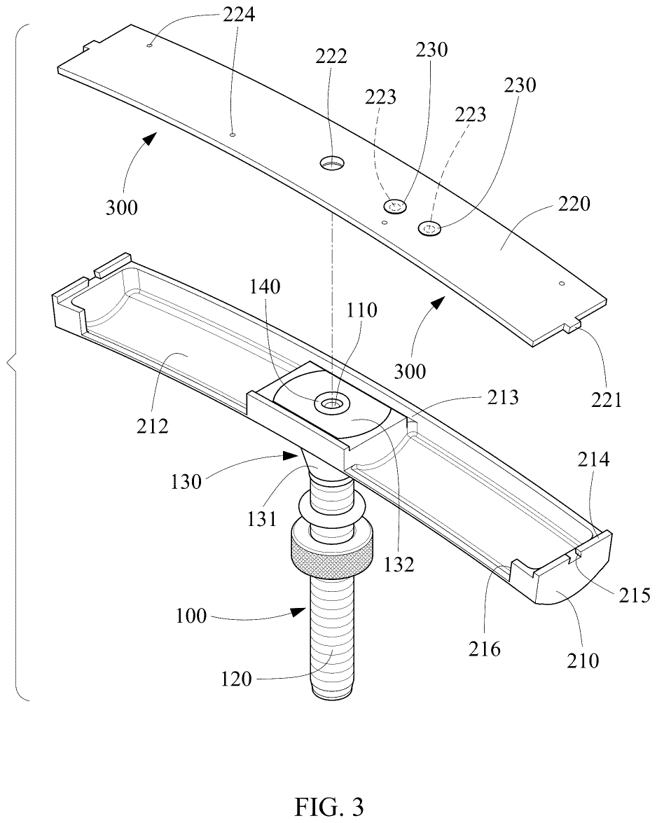

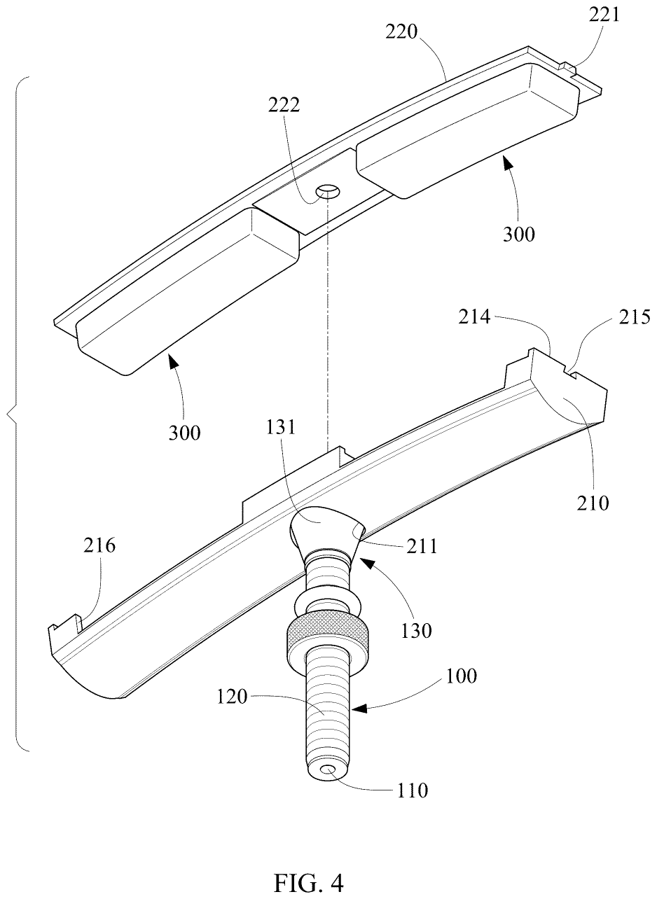

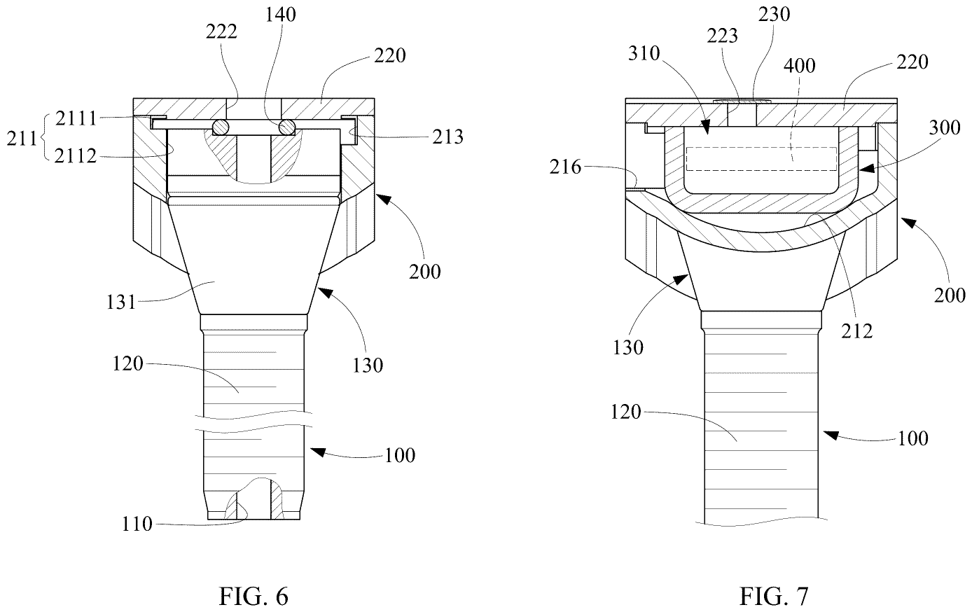

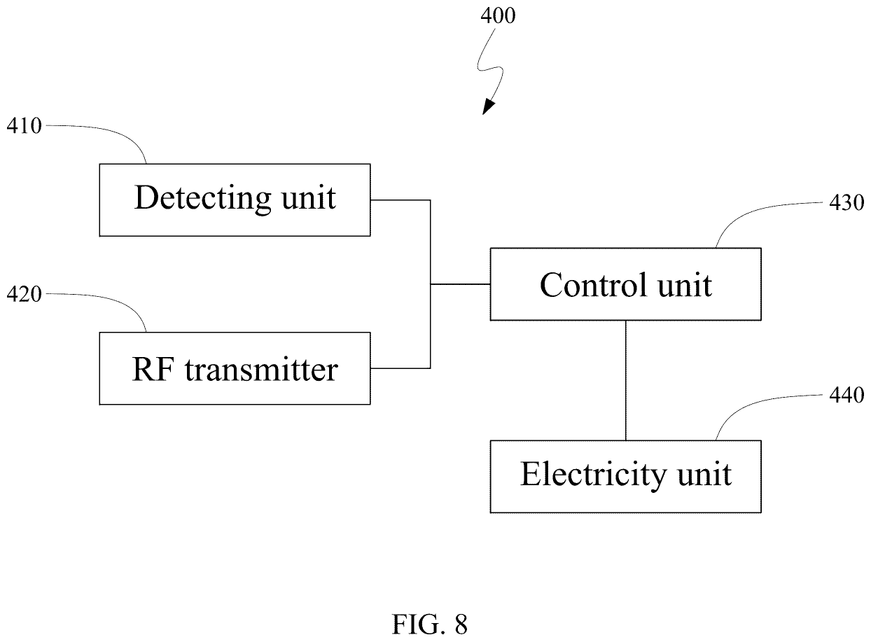

Referring to FIGS. 1 through 8, a pressure detector includes a valve 100, a shell 200, at least one electronic shield 300 and at least one electronic device 400 according to a first embodiment of the present invention.

The valve 100 includes a channel 110, a pipe 120 and a locating element 130. The channel 110 longitudinally extends throughout the valve 100. The pipe 120 and the locating element 130 are two sections of the valve 100. In use, the channel 110 contains a movable core (not shown).

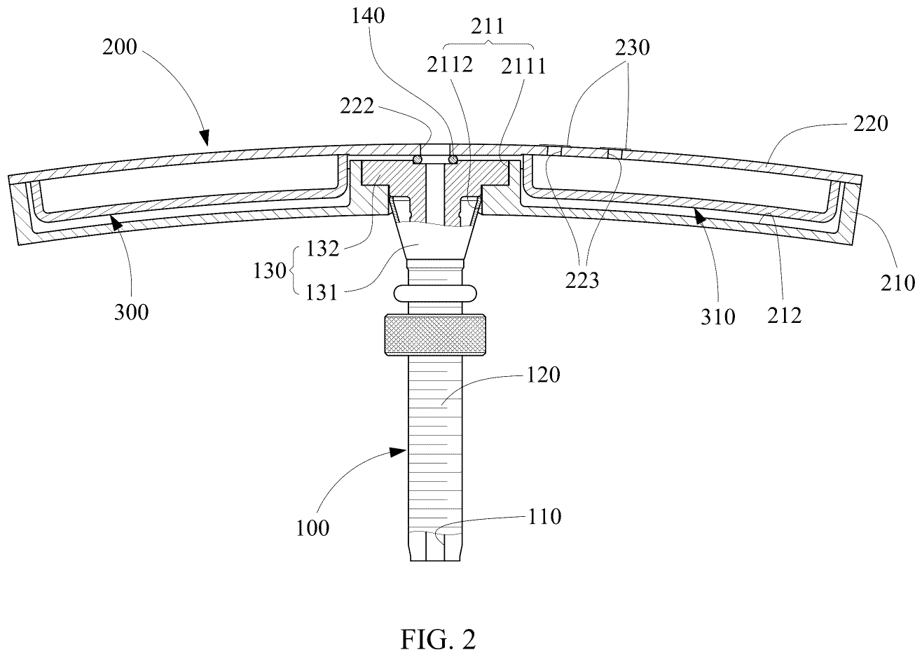

Referring to FIG. 2, the locating element 130 includes a cone 131 and a plate 132. The plate 132 extends over and beyond the cone 131. Preferably, the plate 132 is non-circular such as oval and polygonal.

The shell 200 receives the cone 131 of the locating element 130 of the valve 100. The shell 200 includes a box 210, a cover 220 and waterproof breathable membranes 230.

The pipe 120 of the valve 100 extends through the box 210 so that the locating element 130 is located in the box 210, thereby preventing the valve 100 from spinning. The box 210 includes an aperture 211, at least one groove 212, a passageway 213, at least one wall 214, at least one cutout 215 and at least one window 216.

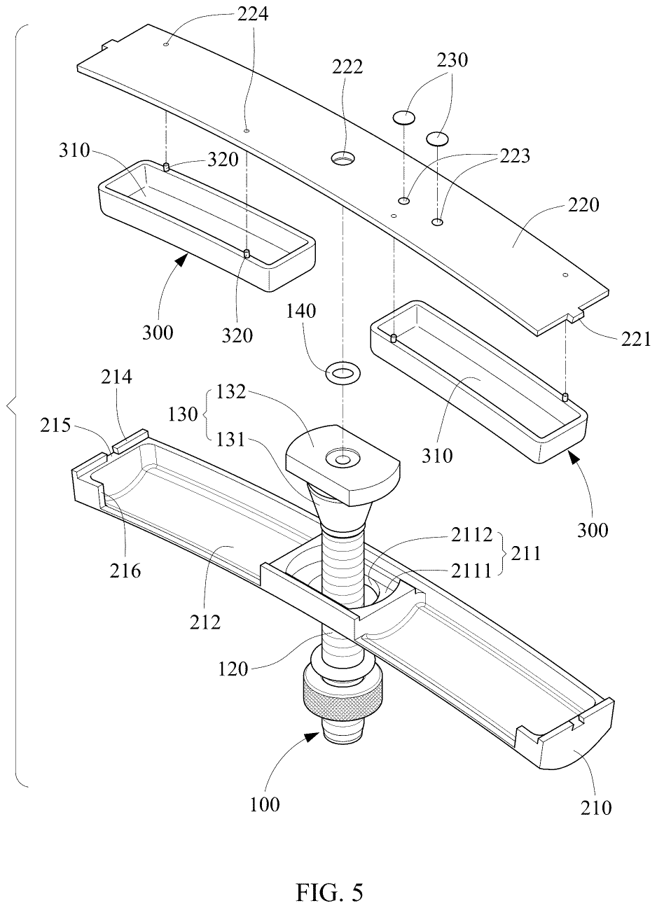

Referring to FIGS. 2 and 5, the aperture 211 extends throughout a central portion of the box 210. The aperture 211 consists of a larger upper section 2111 and a smaller lower section 2112. The terms, “larger” and “smaller”, are given regarding the diameter.

The larger upper section 2111 of the aperture 211 is non-circular such as oval and polygonal corresponding to the plate 132 of the locating element 130. The plate 132 of the locating element 130 is inserted in the larger upper section 2111 of the aperture 211 so that the valve 100 is not rotatable relative to the shell 200.

The grooves 212 are made in an upper face of the box 210 so that the aperture 211 is located between the grooves 212. The larger upper section 2111 of the aperture 211 is adjacent to the grooves 212.

The passageway 213 is also made in the upper face of the box 210. The passageway 213 is adjacent to the aperture 211, and the passageway 213 is in communication with the grooves 212.

The walls 214 are formed at two ends of the box 210. Each of the walls 214 is adjacent to one of the grooves 212.

Each of the cutouts 215 is made in one of the walls 214. The cutouts 215 and the walls 214 are useful in locating the cover 220 relative to the box 210.

Each of the windows 216 is in communication with one of the grooves 212.

The cover 220 is connectable to the box 210, thereby shielding the aperture 211 and the grooves 212. The cover 220 includes at least one protuberance 221, a major orifice 222, at least one minor orifice 223 and at least one recess 224. The cover 220 is secured to the box 210 chemically (via adhesive) or physically (by high-frequency waves).

The protuberances 221 extend from two opposite ends of the cover 220. Each of the protuberances 221 is fitted in one of the cutouts 215 as the cover 220 is attached to the box 210.

The major orifice 222 extends throughout the cover 220. The major orifice 222 is in communication with the channel 110.

The minor orifices 223 extends throughout the cover 220.

The recesses 224 are made in an upper face of the cover 220.

The waterproof breathable membranes 230 are attached to the cover 220. Each of the waterproof breathable membranes 230 covers a corresponding one of the minor orifices 223.

The electronic shields 300 are attached to the cover 220. Each of the electronic shields 300 includes a space 310. Each of the electronic shields 300 is inserted in one of the grooves 212 so that the spaces 310 are closed by the cover 220. The electronic shields 300 are secured to the cover 220 chemically (via adhesive) or physically (by high-frequency waves). The space 310 of each of the electronic shields 300 is in communication with one of the minor orifices 223.

Each of the electronic shields 300 includes protrusions 320. the protrusions 320 are fitted in the recesses 224. The protrusions 320 are triangular, dome-shaped, conical, mushroom-shaped or in any other proper shape to lock the electronic shields 300 to the cover 220.

Referring to FIG. 8, the electronic device is inserted in the spaces 310 of the electronic shields 300. The weight of the electronic device is evenly located at two ends of the shell 200. Each electronic device 400 is a conventional device including but not limited to a detecting unit 410, an RF transmitter 420, a control unit 430 and an electricity unit 440.

The detecting unit 410 detects the pressure in a tire (not shown) after receiving a signal. The detecting unit 410 provides a pressure signal according to the pressure in the tire.

The RF transmitter 420 sends an RF signal corresponding to the pressure signal.

The control unit 430 is electrically connected to the detecting unit 410 and the RF transmitter 420. The control unit 430 receives the pressure signal and instructs the RF transmitter to transmit the RF signal.

The electricity unit 440 is electrically connected to the control unit 430. The electricity unit 440 energizes the entire electronic device 400.

Referring to FIGS. 1 through 8, in assembly, the pipe 120 of the valve 100 extends through the aperture 211 of the box 210 to allow the locating element 130 of the valve 100 to enter the larger upper section 2111 of the aperture 211. As the locating element 130 and the aperture 211 are non-circular, the valve 100 is not allowed to rotate relative to the shell 200.

The detecting unit 410, the RF transmitter 420, the control unit 430 and the electricity unit 440 are evenly located in the spaces 310 of the electronic shields 300 so that the weight of the electronic device 400 is balanced in the electronic shields 300. The cover 220 closes the spaces 310 as the cover 220 is connected to the box 210. Thus, the electronic shields 300 are kept in the grooves 212 of the box 210. The protrusions 320 of the electronic shields 300 extend through the recesses 224 of the cover 220. In addition, adhesive or high-frequency waves are used to ensure that the electronic shields 300 and the electronic device 400 are sealed.

Adhesive can be filled in the grooves 212 of the box 210 through the windows 216 of the box 210. Thus, the electronic shields 300 are sealed.

The electronic device 400 detects the pressure in a tire and accordingly transmits an RF signal to a backend host (not shown).

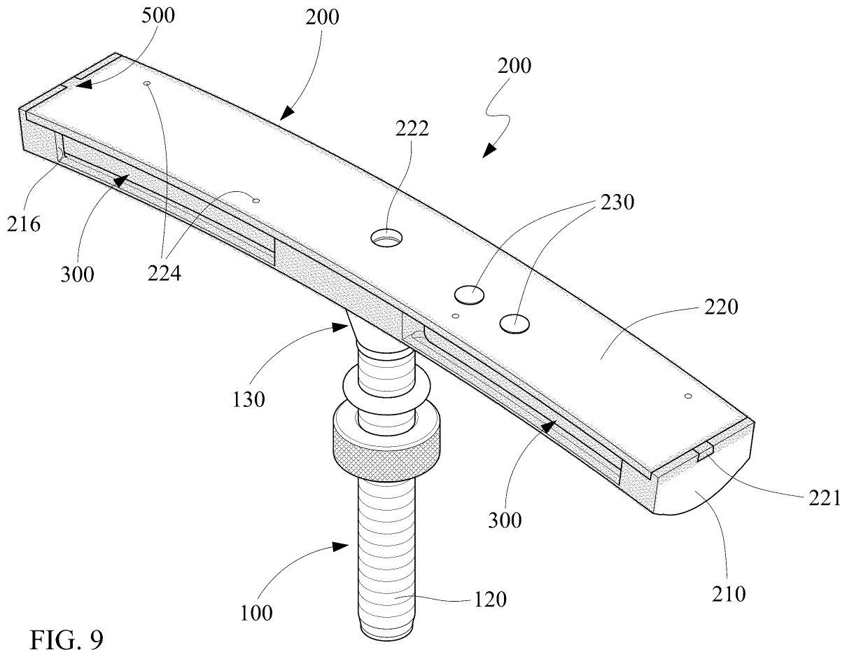

Referring to FIG. 9, a pressure detector additionally includes a coating 500 according to a second embodiment of the present invention. The coating 500 is provided on an external face of the shell 200. In specific, the coating 500 covers and seals the windows 216 and a gap between the box 210 and the cover 220. Thus, the coating 500 blocks liquid such as sealant filled in a tire.

The present invention has been described via the illustration of the embodiments. Those skilled in the art can derive variations from the embodiments without departing from the scope of the present invention. Therefore, the embodiments shall not limit the scope of the present invention defined in the claims.

1. A pressure detector comprising:
a shell (200) comprising:
a box (210) comprising a groove (212); and
a cover (220) connected to the box (210), thereby covering the groove (212); and
an electronic shield (300) inserted in the groove (212) and connected to the cover (220), thereby providing a space (310) between the electronic shield (300) and the cover (220).

2. The pressure detector according to claim 1, wherein the box (210) further comprises at least one wall (214) formed at an end near the groove (212).

3. The pressure detector according to claim 1, wherein the box (210) comprises another groove (212) so that the aperture (211) is located between the grooves (212), wherein the box (210) further comprises two walls (214) formed at two ends, wherein each of the walls (214) is adjacent to one of the grooves (212), wherein each of the walls (214) comprises a cutout (215), wherein the cover (220) comprises a protuberance (221) inserted in the cutout (215).

4. The pressure detector according to claim 1, further comprising a coating covering a gap between the cover (220) and the box (210).

5. The pressure detector according to claim 1, wherein the box (210) comprises a window (216) in communication with the groove (212).

6. The pressure detector according to claim 5, further comprising a coating covering the window (216).

7. The pressure detector according to claim 1, wherein the cover (220) comprises a pair of orifices (223) in communication with the groove (212).

8. The pressure detector according to claim 1, further comprising two waterproof breathable membranes (230) are attached to the cover (220), thereby covering the minor orifices (223).

9. The pressure detector according to claim 1, wherein the cover (220) is secured to the box (210) by a process selected from the group consisting of adhesion and high-frequency waves.

10. The pressure detector according to claim 1, wherein the cover (220) comprises a recess (224), wherein the electronic shield (300) further comprises a protrusion (320) extending throughout the recesses (224).

11. The pressure detector according to claim 8, wherein the protrusion (320) comprises a configuration selected from the group consisting of triangular, oval, conical and mushroom-shaped.
